(19) United States
(12) Patent Application Publication
(10) Pub. No.: US 2025/0328005 A1
(43) Pub. Date: Oct. 23, 2025

(54) OPTICAL SCANNER AND SCANNING METHOD

(71) Applicant: CORNELL UNIVERSITY, Ithaca, NY (US)

(72) Inventors: Chunhui XU, Ithaca, NY (US); Eric HEBERT, Ithaca, NY (US)

(21) Appl. No.: 19/122,117

(22) PCT Filed: Oct. 19, 2023
(86) PCT No.: PCT/US2023/035545

§ 371 Date: Apr. 17, 2025

Related U.S. Application Data
(60) Provisional application No. 63/417,605, filed on Oct. 19, 2022.

(51) Int. Cl. G02B 26/10; G02B 26/08

(52) U.S. Cl. CPC G02B 26/101; G02B 26/0816

(57) ABSTRACT

An optical scanner includes a first 1D-beam-shaping optical-element, a scanning optical-element, and a second 1D-beam-shaping optical-element. The first 1D-beam-shaping optical-element flattens an incident optical beam in a vertical direction to yield a flattened input-beam that propagates toward the scanning optical-element. The scanning optical-element deflects the flattened input-beam, in a scanning plane, to yield a flattened output-beam that propagates to the second 1D-beam-shaping optical-element along one of multiple optical beam paths in the scanning plane. The second 1D-beam-shaping optical-element collimates the flattened output-beam.

### CROSS-REFERENCE TO RELATED APPLICATIONS

This application claims the benefit of U.S. Provisional Application No. 63/417,605, filed on 19 Oct. 2022, the disclosure of which is incorporated herein by reference in its entirety.

### GOVERNMENT RIGHTS

This invention was made with government support under Award Number 1707312 awarded by the National Science Foundation. The government has certain rights in the invention.

### BACKGROUND

Optical methods provide high-resolution, non-invasive measurement of neural function, ranging from single neurons to entire populations, in the intact brain. Importantly, optical methods allow cell type-specific recordings. Nevertheless, the limited penetration depth, spatial scale and temporal resolution remain the main challenges for optical imaging. The major technology used for cellular-level imaging in scattering brains is laser scanning multiphoton microscopy (MPM). Because of the point scanning nature of laser scanning microscopy (LSM), the speed of the optical scanner determines the imaging frame rate, even when there is sufficient signal strength for fast imaging. Optical scanning methods used today are largely based on mature technologies. The oldest of these technologies, galvanometers (i.e., galvos), continues to see the most use due to a combination of compactness, ease of use, and the ability to steer the beam along an arbitrary path. The scanner includes a single mirror mounted on a post rotated by an actuator. Another common technology, resonant scanners (i.e., resonant galvos), includes primarily the same hardware, but instead of moving arbitrarily, the mirror is driven at its resonant frequency. As a result, while the resonant scanner cannot be directed arbitrarily and lacks the scan line linearity, it can be driven much faster. Even though there is ever growing demand for high speed imaging, particularly when recording large scale brain activity, the speed of galvo-scanners has not improved significantly for the last thirty to forty years due to various fundamental and practical difficulties.

### SUMMARY OF THE EMBODIMENTS

Embodiments disclosed herein improve the scan speed of galvanometer-based optical scanners (galvo-scanners), and increase the imaging speed of LSM using galvo-scanners.

In a first aspect, an optical scanner is disclosed. The optical scanner includes a first 1D-beam-shaping optical-element, a scanning optical-element, and a second 1D-beam-shaping optical-element. The first 1D-beam-shaping optical-element flattens an incident optical beam in a vertical direction to yield a flattened input-beam that propagates toward the scanning optical-element. The scanning optical-element deflects the flattened input-beam, in a scanning plane, to yield a flattened output-beam that propagates to the second 1D-beam-shaping optical-element along one of multiple optical beam paths in the scanning plane. The second 1D-beam-shaping optical-element collimates the flattened output-beam.

In a second aspect, a method for angularly scanning an optical beam is disclosed. The method includes forming a flattened input-beam from the optical beam by decreasing a height of the optical beam in a vertical direction, perpendicular to a scanning plane, while substantially maintaining a width of the optical beam in a horizontal direction. The method also includes deflecting the flattened input-beam to yield a flattened output-beam; and forming an expanded optical beam from the flattened output-beam by increasing a height of the flattened output-beam in the vertical direction.

### BRIEF DESCRIPTION OF THE FIGURES

FIGS. 1 and 2 are schematic of an optical scanner that includes the 1D-beam-shaping optical-elements, in an embodiment.

FIG. 3 is a flowchart illustrating a method for angularly scanning an optical beam.

FIG. 4 is a plot of a galvanometer's scan angle as a function of driving frequencies and driving voltage, in an embodiment.

FIG. 5 illustrates effects of decreasing load moment of inertia on resonant amplitude (top) and resonant frequency (bottom), in an embodiment.

FIG. 6 is a plot of Strehl ratio as a function of scan angle for a galvo modification with a first commercial off-the-shelf (COTS) cylindrical lens, and a second COTS cylindrical lens, and a custom optimized set of cylindrical surfaces forming afocal Galilean telescopes.

FIG. 7 is a schematic of the optimized Galilean telescope of FIG. 6.

FIG. 8 is a schematic of a multiphoton microscope that includes two instances of the optical scanner of FIG. 1, in an embodiment.

FIG. 9 is a legend defining the meaning of symbols used in subsequent schematics of optical systems.

FIG. 10 is a schematic of an optical scanner, which is an example of the optical scanner of FIG. 1.

FIGS. 11 and 12 are schematics of a one-dimensional Keplerian telescope and a one-dimensional Galilean telescope, respectively, which are examples of the 1D-beam-shaping optical-elements of FIG. 10.

FIGS. 13-20 depict respective examples of optical-scanners pairs coupled in series that together scan in incident beam in two orthogonal directions.

FIG. 21 is a schematic of a beam scanning optical element scanning a beam onto a cylindrical mirror having a planer surface facing the beam scanning optical element.

FIG. 22 is a schematic of a beam scanning optical element scanning a beam onto a cylindrical mirror having a concave surface facing the beam scanning optical element.

### DETAILED DESCRIPTION OF THE EMBODIMENTS

### 1. Design Tradeoffs

Imaging speed, spatial resolution and field-of-views (FOVs) are critical concerns in large scale brain activity recording. The resolvability of the image is dependent on the capability of the scanner as much as the optical elements of the microscope. The numerical aperture (NA) of the objective and beam width at the back aperture determine the size of a pixel while the angular range of the scanner and lens focal length determine the FOV.

More than the angular range itself, optical scanners are fundamentally limited by the product of their angular range and beam-aperture size, which we define as a. This parameter defines the number of resolvable points after focusing the beam with a lens. When the lens has a focal length f, and the beam-aperture a is scanned over an angle θ, the scan line is f sin(θ) wide with a focal spot size of λf/πa. The number of resolvable points is then πα/λ for small scan angles. Since a is an optical invariant, it cannot be changed by manipulating the beam using static optical elements. If, for example, one used a telescope to double the beam size, then angular range would simultaneously decrease by half, conserving α. As a result, the number of resolvable points in the scan line is fixed by the scanner. For high speed scanning with high spatial resolution and large FOV, the scanner may scan over a wide angle, have a large beam aperture, and scan at a high speed.

The scanning speed of galvanometers is limited primarily by moment of inertia. Assuming uniform density, the scan mirror behaves like a plank rotating along the center axis with width w, height h, and depth d. The moment of inertia of such a plank is:

$$I = \frac{1}{12} ρ wdh ( {w}^{2} + {d}^{2} ) \approx \frac{1}{12} ρ {dhw}^{3} , \qquad ( 1 )$$

assuming d is much smaller than w. The moment of inertia scales with the fourth power of the beam aperture size (i.e., hw³). The step response of a galvanometer can meanwhile be modelled as:

$$t = 2 \sqrt{I β / τ} , \qquad ( 2 )$$

where t is the step response time, β is the angular displacement, and τ is the available torque from the motor. Consequently, there is a direct conflict between increasing the aperture size (i.e., w and h), which is proportional to the number of resolvable points in the image plane, and decreasing mirror inertia for high speed scanning. The balance of these two conflicting requirements has limited commercially available galvanometer scanners at approximately the same speed for many years. Exotic mirror structures and materials with a higher stiffness to density ratio like silicon carbide and beryllium have been used to reduce the inertia of scan mirrors and scan faster; however, these enhancements are expensive and limited in the extent to which they can decrease the mass of the mirror.

Embodiments disclosed herein allow for a dramatic reduction in mirror mass which far exceed the limits of the previous attempts which utilized novel materials or structures to decrease moment of inertia while maintaining the number of resolvable points of the scanner. Embodiments disclosed herein leverage the uniaxial nature of galvanometer scanning, i.e., a galvo-scanner scans one spatial dimension. Therefore, the optical invariant only constrains the optical resolution and mirror size in one direction, leaving the orthogonal dimension free for manipulation. For example, by using a cylindrical lens to focus the beam onto the scan mirror along the axial direction of the galvanometer (i.e., the non-scanning direction) and another cylindrical lens to recollimate the beam after scanning, we reduce the size of the scan mirror dramatically along the non-scanning direction. Since beam shaping happens perpendicularly to the scanning direction, it does not affect the resolution parameters. At the same time, the one-dimensionally compressed beam has a smaller size on the scan mirror, allowing the scan mirror to be shortened to reduce its moment of inertia and increase the scan speed.

Embodiments disclosed herein include a similar modification to resonant scanners. While reducing the moment of inertia of the mirror increases the resonant frequency, this may come at the cost of the amplitude of operation. Yet, when the scanning mirror is wider along the scanning direction but shorter along the non-scanning direction, the optical scanner increases the spatial resolution (larger beam aperture) while maintaining the resonant frequency. Therefore, the optical scanner has a larger FOV for resonant scanners, eliminating one of the shortcomings of existing resonant scanners.

### 2. Reduction of Beam Size and Aberrations

2.1 One aspect of the present embodiments includes reducing the beam size in the dimension perpendicular to scanning, which allows for a decrease in inertia of the scan mirror without reducing the aperture of the galvo scanner.

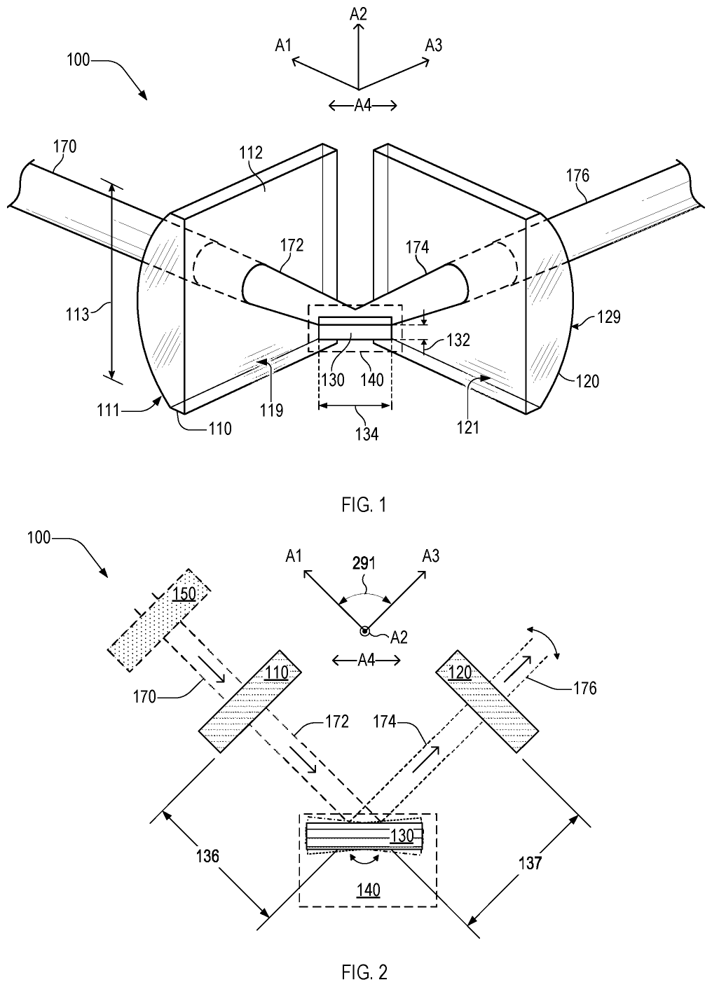

A central innovation of embodiments disclosed herein is the manipulation of the non-scanned dimension of a beam incident on an optical galvo-scanner. Ordinarily, the optical invariant limits the benefit of beam resizing at the scanner. A smaller beam may be expanded to fit the back aperture of the objective, shrinking the angular scan range and FOV at the sample in direct proportion. This is only true, however, in the direction of scanning. In embodiments, a cylindrical lens focuses the beam in the non-scanned direction onto the scanning mirror before using an identical lens to recollimate it after the scanner (FIG. 1). When all manipulation is happening orthogonal to the direction of motion, the resolution parameter of the scanner is unaffected. At the same time, we can shorten the scanning mirror in the axial direction (i.e., the non-scanning direction), decreasing its mass and moment of inertia in direct proportion. For inertially dependent scan systems, like galvanometers and resonant scanners, a scanner with low mass and inertia is be able to move faster under the same torque.
2.2 Another aspect of the present embodiments includes optimizing the beam shaping optics, which reduces the impact of aberration in imaging.

Shaping the beam with simple cylindrical lenses, while conceptually straightforward, introduces undesirable aberrations into the imaging system. Initial Zemax simulations show that simple plano-convex cylindrical lenses require long focal lengths to maintain a useful Strehl ratio across the imaging FOV. This is likely due to ray-bending happening at two surfaces. A more complex setup with more degrees of freedom improves this. Additionally, optical performance degrades quickly for wide scan angles regardless of focal length. This is likely due to the changing path length to the lens over the scan angle.

In embodiments, beam shaping optics reduce the optical aberration and increase the scan angular range with near diffraction-limited optical performance. In certain embodiments, a one-dimensional (1D) beam expander and shrinker improve the optical performance instead of using cylindrical lenses.

### 3. Approach

### 3.1 Increased Scanning Speed

In embodiments, scanning speed is improved by reducing the scan mirror size along the non-scanning dimension. The reduced scan mirror size results in a decreased scanning moment of inertia, which enables a high maximum line rate (scan speed) and increased angular range.

FIG. 1 is a schematic isometric view of an optical scanner 100. FIG. 2 is a plan view of optical scanner 100. FIGS. 1 and 2 are best viewed together in the following description.

FIGS. 1 and 2 depict axes A1, A2, A3, and A4. Unless otherwise specified, heights of objects herein refer to the object's extent along axis A2. Also herein, a horizontal plane is parallel to the A1-A3 plane, the A2 axis is perpendicular to the A1-A3 plane. In embodiments, vertical planes and directions are parallel to the A2 axis. In other embodiments, vertical planes and directions are parallel to the A1-A3 plane. Axis A4 is perpendicular to axis A2 and parallel to the A1-A3 plane. Herein, a scanning plane may refer to either a plane that is parallel to the A1-A3 plane, or to a plane that is perpendicular to the A1-A3 plane. FIG. 2 denotes an angle 291 between axes A1 and A3. Vertical planes and directions are perpendicular to the scanning plane. Angle 291 is greater than zero and less than 180 degrees. For example, angle 291 may be between 60° and 120°.

Optical scanner 100 includes a 1D-beam-shaping optical-element 110, a scanning optical-element 130, and a 1D-beam-shaping optical-element 120. For sake of brevity, 1D-beam-shaping optical-element 110 and 1D-beam-shaping optical-element 120 are also referred to as optical-element 110 and optical-element 120, respectively. Axes A1 and A3 may be perpendicular to respective principal planes of optical elements 110 and 120.

In an example mode of operation, optical-element 110 flattens an incident optical beam 170 in a vertical direction to yield a flattened input-beam 172 that propagates toward scanning optical-element 130. Scanning optical-element 130 deflects flattened input-beam 172, in a horizontal or vertical scanning plane, to yield a flattened output-beam 174 that propagates to optical-element 120 along one of multiple optical beam paths in the scanning plane. Optical-element 120 collimates flattened output-beam 174 to yield an output beam 176. In embodiments, elements 110, 120, and 130 define the multiple optical beam paths.

Scanning optical-element 130 has a vertical dimension 132 and a horizontal dimension 134, which may exceed vertical dimension 132. Horizontal dimension 134 may exceed vertical dimension 132 by at least a factor of two. Scanning optical-element 130 may be a mirror that (i) faces each of optical-element 110 and optical-element 120 and (ii) reflects flattened input-beam 172 to optical-element 120. Scanning optical-element 130 may be a refractive optical element such as a prism or a lens.

In embodiments, optical scanner 100 includes a galvo scan head 140 that includes scanning optical-element 130. When scanning optical-element 130 is a mirror, head 140 may pivot scanning optical-element 130 about a vertical axis (parallel to axis A2) or about a horizontal axis (parallel to axis A4). When scanning optical-element 130 has a reflective surface, the vertical axis may be perpendicular to a surface normal to the reflective surface. The reflective surface may be in a plane that is parallel to axis A4.

Optical-element 110 may be a down-collimator that compresses the incident optical beam in the vertical direction. Optical-element 120 may be an up-collimator that expands the flattened output-beam in the vertical direction.

Optical-element 110 has an entrance clear-aperture on a side of optical-element 110 facing away from scanning optical-element 130. The entrance clear-aperture has a height 113 along axis A2. Vertical dimension 132 of scanning optical-element 130 may be less than height 113. Vertical dimension 132 may be less than height 113. Defining β as the ratio of vertical dimension 132 to height 113, beta may be less than one. Ratio β may be between 0.3 to 1.0, and any value therebetween. For example, β may be between 0.35 and 0.50.

Optical-element 110 may have optical power in a vertical cross-sectional plane thereof, where this plane is parallel to the A1-A2 plane. In such embodiments, optical-element 110 may lack optical power in a horizontal plane that intersects optical-element 110. Vertical dimension 132 may be less than a factor Mx times a diffraction-limited vertical height of a focused beam formed by optical-element 110. Factor Mx may be between two and six or any subrange therein, such between three and five.

Optical-element 120 may have optical power in a vertical cross-sectional plane thereof, where this plane is parallel to the A2-A3 plane. In such embodiments, optical-element 120 may lack optical power in a horizontal plane that intersects optical-element 120.

Optical-element 110, optical-element 120, and scanning optical-element 130 may function as a one-dimensional afocal telescope, where the focusing is along axis A2. In such embodiments, optical-element 120 may be located at the shared internal focal plane of (within) the afocal telescope. In FIG. 2, a distance 136 denotes a distance between a first location on scanning optical-element 130 and a first principal plane of optical-element 110. Similarly, distance 137 denotes a distance between a second location on scanning optical-element 130 and a first principal plane of optical-element 120. Distances 136 and 137 are in directions that are parallel to axis A1 and A3, respectively. The second location may be the same as the first location.

When elements 110, 120, and 130 are arranged as an afocal telescope: distance 136 may be substantially equal to a focal length of optical-element 110, and distance 137 may be substantially equal to a focal length of optical-element 120. For example, (i) distance 136 may differ from a focal length of optical-element 110 by less than a depth of focus of optical-element 110, and (ii) distance 137 may differ from a focal length of optical-element 120 by less than a depth of focus of optical-element 120.

Optical-element 110 has an object-side surface 111 and an image-side surface 119. Optical-element 120 has an object-side surface 121 and an image-side surface 129. At least one of object-side surface 111 and image-side surface 119 may lack axial symmetry about an axis that is parallel to axis A1 and intersects surfaces 111 and 119.

At least one of object-side surface 121 and image-side surface 129 may lack axial symmetry about an axis that is parallel to axis A3 and intersects surfaces 121 and 129. At least one of object-side surface 111 and image-side surface 119 may be non-planar and symmetric (e.g., exhibit mirror symmetry) about a horizontal plane. At least one of object-side surface 121 and image-side surface 129 may also be non-planar and symmetric (e.g., exhibit mirror symmetry) about this horizontal plane. This horizontal plane may be the scanning plane, or be parallel to the scanning plane.

Examples of optical-element 110 and optical-element 120 include a cylindrical lens, a cylindrical mirror, a one-dimensional parabolic mirror, a biconic lens, a Powell lens, and any combination thereof.

Optical scanner 100 may include an optical-element 150 that has adjustable optical power in a vertical plane, such as A1-A2 plane. When optical scanner 100 includes optical-element 150, optical-element 110 is between optical-element 150 and scanning optical-element 130. When optical-element 120 introduces defocus upon output beam 176, optical-element 150 compensates for this defocus by introducing differing amounts of defocusing (or focusing) to incident optical beam 170. Examples of optical-element 150 include a liquid lens, a deformable mirror, and a spatial light modulator.

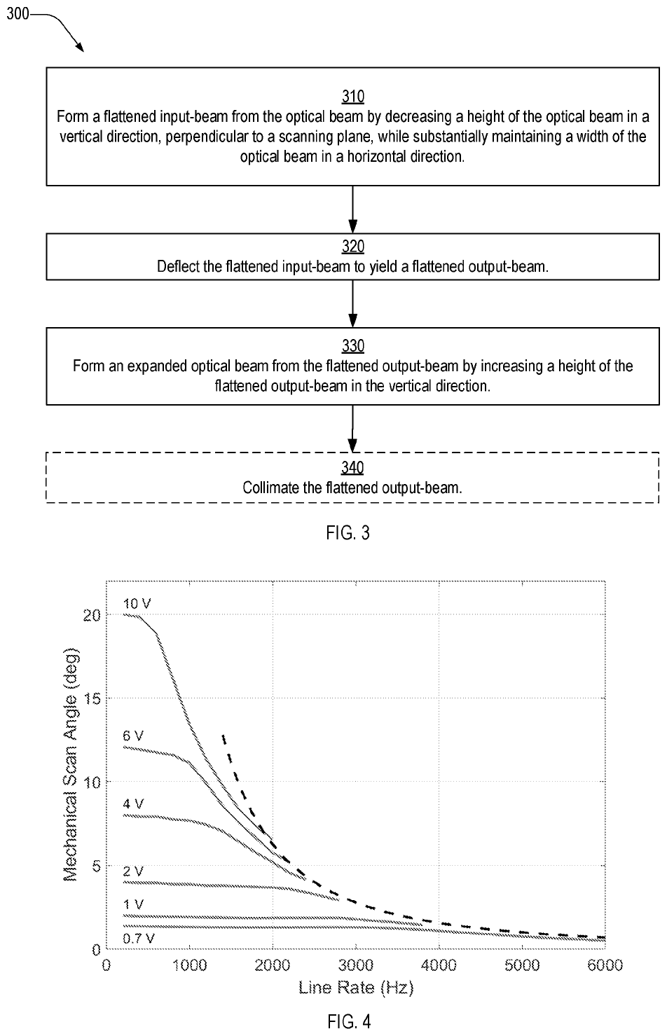

FIG. 3 is a flowchart illustrating a method 300 for angularly scanning an optical beam. Method 300 includes steps 310, 320, and 330. Method 300 may also include step 340.

Step 310 includes forming a flattened input-beam from the optical beam by decreasing a height of the optical beam in a vertical direction, perpendicular to a scanning plane, while substantially maintaining a width of the optical beam in a horizontal direction. In an example of step 310, incident optical beam 170 propagates parallel to axis A1 and optical-element 110 forms flattened input-beam 172 from incident optical beam 170 by decreasing a height of incident optical beam 170 along axis A2 while substantially maintaining a width of optical beam 170 along axis A3. Step 310 may occur before the optical beam reaches the scanning optical element.

Step 320 includes deflecting the flattened input-beam to yield a flattened output-beam. In an example of step 320, scanning optical-element 130 deflects flattened input-beam 172 to yield flattened output-beam 174. In step 320, deflecting the flattened input-beam may include one or more of reflecting the flattened input-beam, refracting the flattened input-beam and rotationally oscillating the scanning optical-element through an angular scanning range. The rotational oscillation is around a vertical axis.

Step 330 includes forming an expanded optical beam from the flattened output-beam by increasing a height of the flattened output-beam in the vertical direction. In a example of step 330, flattened input-beam 172 is a converging beam and scanning optical-element 130 is located within a beam waist flattened input-beam 172, and flattened output-beam 174 is a diverging beam that expands along axis A2 as it propagates from scanning optical-element 130 to optical-element 120. In a second example of step 330, optical-element 110 is a beam expander that vertically compresses incident optical beam 170 such that flattened input-beam 172 is collimated along axis A2, and optical-element 120 is a beam expander that vertically expands flattened output-beam 174 to yield output beam 176.

Step 340 includes collimating the flattened output-beam. In an example of step 340, optical-element 120 collimates flattened output-beam 174 and transmits the collimated beam as output beam 176.

Galvanometer performance is highly dependent on scan angle. As shown in FIG. 4, they can be driven at large angles and at moderately high frequencies, but not simultaneously at large angles with high frequencies. Working with a Thorlabs GVS002 scanner, voltage traces were taken from the built-in position sensor to capture angular range when driven at different frequencies and voltages. The input voltage commands the galvo to an angle which is linearly proportional to that voltage. Our scanner accepts an input from −10 V to +10 V, corresponding to an angular range of −20 degrees to +20 degrees. We drove the scanner with a symmetric triangle wave, starting at 100 Hz and increasing in increments of 100 Hz until the scanner stopped responding at ˜6 kHz line rate. The behavior shown in FIG. 4 is consistent with data collected by others who have driven galvanometric scanners beyond their listed line-rate limits.

The proposed galvo-scanner may be driven at frequencies several times beyond the typical line rate of 2 kHz. Yet, as frequency increases, the scanner cannot travers the full FOV before the input signal reverses direction. As a result, the angular range decreases until the scanner stops functioning. Additionally, the scanner response become less linear and more sinusoidal the more it deviates from the command signal, further decreasing the scan range that would be useful for many applications. For example, at around 0.7 V input voltage, the scanner can be driven at very high frequencies; however, the angular range decays towards zero. Based on the line scanning resolution estimate described above, this galvanometer could scan about 130 points per line at 6 kHz. Due to nonlinearity of the scanning curve, the usable portion would likely be closer to 70 points per line. Thus, while one can operate the system at very high speeds, the angular range and resultingly low resolution parameter render the system useless for most applications.

The cutoff frequency (i.e., the maximum drive frequency to still achieve a desirable angular range) varies with driving signal voltage; however, the data points follow a trend. Assuming that in the low frequency range, any angular range can be accommodated, and that as the scan angle approaches zero, the accessible frequency is unbounded, the data was fit to θ_{c}=λf^{-b}, where f is the cutoff frequency, θ_{c} is the cutoff angle (i.e., the maximum scan angle achievable at frequency f), and A and b are fit constants. The fit is plotted in FIG. 4 as a dashed black line. The fitting exponent was 2, consistent with a system whose performance is limited by a fixed maximum torque and moment of inertia (see Eq. 2). FIG. 2 confirms that the speed of the tested galvo-scanner is limited by inertia. Therefore, by reducing the mirror moment of inertia, constant A increases in inverse proportion, allowing for high speed operation with a large angular scanning range.

### 3.1.1: High-Frequency Scanning and Large Beam Aperture.

Achieving high frequency scanning by reducing the scan mirror inertia. In embodiments, the large scan mirror has an extent along the non-scanned direction that is between two millimeters and eight millimeters. The optical scanner may have a line rate exceeding 6 kHz with mechanical scan angle of at least nine degrees (+4.5 degrees) for a beam size of approximately 3 mm.

Achieving large beam aperture by reshaping the scan mirror. In embodiments, the a scanning optical element 130 is shorter along the non-scanned direction (along axis A2) and wider along the scanned direction. This can maintain the moment of inertia (Eq. 1), and resulting frequency curves shown in FIG. 4, while increasing the effective beam aperture and number of resolvable points across the scan line. This approach is particularly valuable for large FOV (LFOV) microscopes. While existing LFOV microscopes can achieve 5×5 mm or larger FOVs, the FOVs are too large for resonant scanners (see section 3.1.2 below). Galvo scanners can achieve such large FOVs but only operating at the low end of the scan speed for the required scan angles (e.g., see data shown in FIG. 4). By increasing the scan aperture without increasing the moment of inertia, the disclosed scanner reduces the required scan angular range, therefore, increasing the achievable scan speed.

One concern of decreasing the mirror size in the axial direction is the decrease in mirror stiffness, potentially leading to more dynamic deformation at higher scanning frequencies. Yet, the decrease in stiffness is accompanied by the decrease in total mass. In addition, resonant galvo-scanners routinely operate at speed >16 kHz line rate with scan mirrors. In embodiments, the discloses non-resonant galvos do not approach the speed of resonant galvos, such that this concern does not limit the scan speed using non-resonant galvos scanners.

3.1.2: Increased Resonant Scanning Frequency without Significantly Reduced Scanning Range.

The relationship between moment of inertia, frequency, and aperture is more complex for a resonant scanner. Mechanical resonance may be described with the sinusoidally driven second order differential equation

$$I \frac{{d}^{2} θ}{{dt}^{2}} + c \frac{d θ}{dt} + k θ = {F}_{o} cos ( ω t + {φ}_{d} ) ,$$

where c is a drag constant, k is the spring constant, Fₒ is the maximum torque, ω is the driving frequency, and φ_{d} is the phase offset. Ignoring the transient component, the steady state solution has the form of θ(t)=A cos(ωt+φ), where φ is independent of time. The angular scanning range has the form of

$$A = ( {F}_{o} / I ) / \sqrt{{( 2 ω {ω}_{o} ϛ )}^{2} + {( {ω}_{o}^{2} - {ω}^{2} )}^{2}} ,$$

where ωₒ=\sqrt{k/I} and ζ=c/2\sqrt{Ik}. The resonant frequency is then located at ωᵣ=@ωₒ\sqrt{1−2ζ²}. Notably, this frequency is only real in a significantly underdamped system where I>c²/2k. The resonant frequency increases with decreasing moment of inertia for I>2c²/k. This can be assumed for a significantly underdamped system. At resonance, the angular amplitude envelope then reduces to A=FₒI/c\sqrt{Ik−c²/4}.

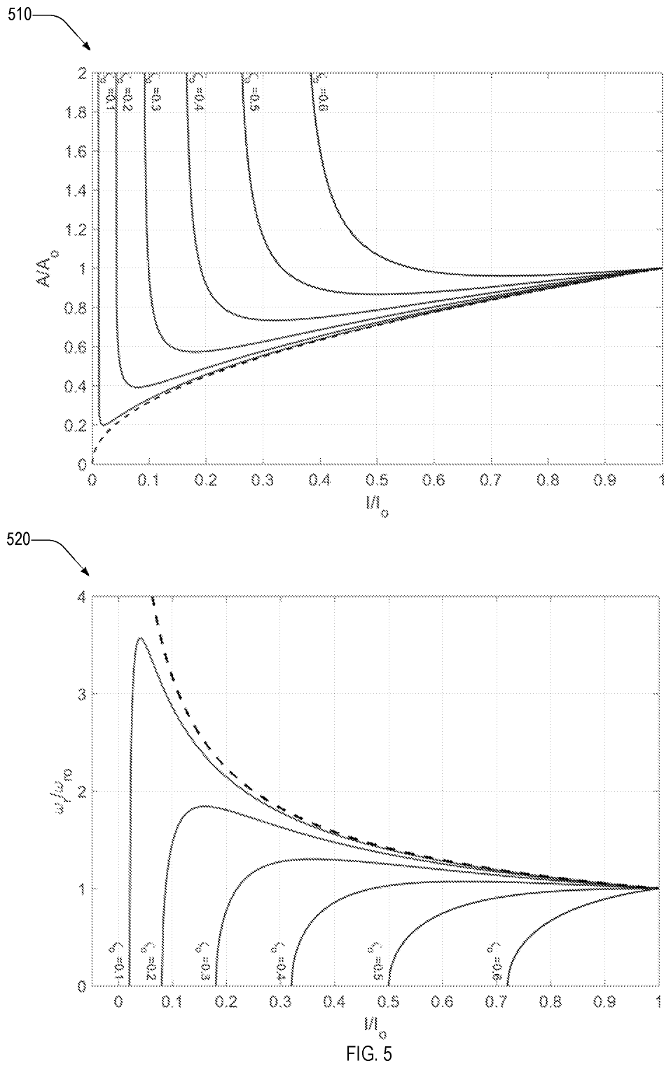

When changing this system from having an initial moment of inertia of Iₒ to I′=aIₒ, where a is less than 1, the ratio of the new resonant amplitude to the previous one is a\sqrt{1−ζ²}/\sqrt{a−ζ²}. Similarly, the ratio of the new resonant frequency to the old is \sqrt{a−2ζ²}/a\sqrt{1−2ζ²}. These curves are drawn in plots 510 and 520 of FIG. 5 for various values of dampening constant ζ₀. The curves were calculated for different initial dampening constants, with the black dotted lines representing the curve with an undampened oscillator.

Generally, the resonant frequency and amplitude of oscillation move in different directions, which means that the increase in scan speed comes at the cost of reduced angular range; however, this cost is less significant than if the aperture were decreased without using disclosed embodiments herein, since it would cause a loss in both aperture and angular range.

Alternative Approach. Embodiments of the optical scanner include 1D beam shaping mechanism to increase the effective beam aperture of the resonant scanner while maintaining the moment of inertia, effectively gaining resolution and/or FOV without sacrificing the scan speed. Since resonant galvos have much smaller angular scan range (e.g., ±5 degrees) than non-resonant galvos (±20 degrees), increasing the effective beam aperture of resonant galvo scanner is highly significant for improving the performance of the resonant scanner. It allows a resonant galvo to scan a large FOV (˜ mm scale) with high spatial resolution.

### 3.2: Optimize the 1D Beam Shaper and Validate the New Scanning System in a Multiphoton Microscope.

### 3.2.1: Improved Strehl Ratio

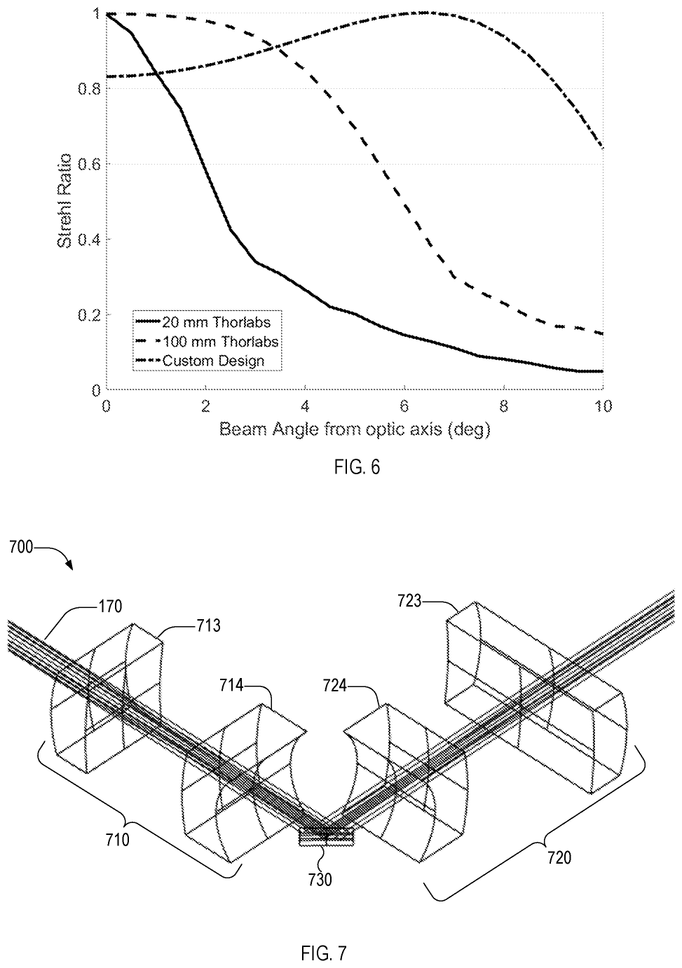

Compact systems require a shorter focal length cylindrical lens system. Typically higher NA lenses require more surfaces and degrees of freedom than a plano-convex singlet provides. As a result, shorter focal length cylindrical lenses struggle to maintain a high Strehl ratio beyond a small scan angle. This is shown in FIG. 6. Zemax was used to simulate different spatial beam compression optics with a galvanometer with a 2 mm by 8 mm scanning mirror. The Strehl ratio as a function of beam angle from the optic axis (double the mechanical galvo angle) is shown for the same setup using a pair of either 20 mm or 100 mm plano-convex Thorlabs cylindrical lenses. Performance drops off much more quickly for the shorter focal length lens.

Additionally, the 1D focusing of a cylindrical lens may lead to problems when scanning at large angles in the scanning plane. As the galvanometer mirror scans, the angle of the beam to the optic axis increases and the net distance the beam propagates to the cylindrical lens increases. When the beam focus is at the mirror, which is fixed in space, the beam may then be wider at the first bending surface. Since the cylindrical lens has translational symmetry along the scanning direction, this leads to a non-constant degree of collimation across the FOV. This restricts the angular range of the scanner while maintaining useful beam collimation along the non-scanned direction regardless of focal length.

As a potential solution to this problem, the single cylindrical lens may be replaced with an afocal system of two or more lenses (i.e., a 1D beam expander or shrinker). Instead of focusing on the mirror, the beam would then be collimated with an asymmetric profile fitting the shape of the scan mirror.

FIG. 7 shows an example optical scanner 700, which includes a beam shrinker 710, a beam expander 720, and a scanning optical element 730, which are respective examples of optical-element 110, optical-element 120, and scanning optical-element 130. Beam shrinker 710 includes a positive lens 713 and a negative lens 714. Beam expander 720 includes a positive lens 723 and a negative lens 724.

Beam shrinker 710 and beam expander 720 form a Galilean telescope in one dimension. Beam shrinker 710 vertically compresses optical beam 170 before the beam reaches scanning optical-element 730. Beam expander 720 reshapes the optical beam it to a circular beam after beam expander 720.

Assuming the ability to shape all surfaces of the optics, beam shrinker 710 and beam expander 720 are designed to provide a system which is more compact in addition to having greater off axis performance. The corresponding Strehl ratio as a function of beam angle is shown in FIG. 6, alongside the performance for the off-the-shelf plano-convex lenses mentioned earlier. The performance is significantly improved, allowing for a Strehl ratio above 0.8 (close to diffraction-limited performance) for up to 9 degrees. At the same time, the last surface of the lens pair is less than 50 mm away from the galvanometer, making it more compact than the 100-mm focal length singlet.

### 3.2.2: Improved Multiphoton Microscope for Brain Imaging

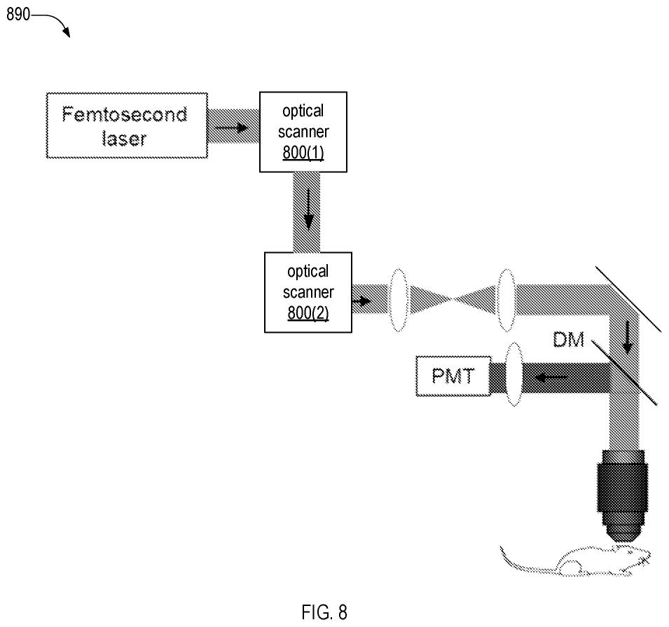

Embodiments of optical scanners disclosed herein may be integrated into a multiphoton microscope 890, as shown in FIG. 8. Microscope 890 includes a horizontal optical scanner 800(1) and a vertical optical scanner 800(2), each of which is an example of optical scanner 100. Such a microscope may be used to image neural activity within a mouse brain.
(1) In an example use scenario, embodiments of non-resonant galvanometer scanners disclosed herein perform standard raster scanning at >6 kHz line rate, achieving close to video-rate imaging with 256 lines/frame.
(2) Embodiments of non-resonant galvanometer scanner systems may include two scanners. Such embodiments may exhibit fast imaging along a 2D random scan path. Since both galvos operate on a similar time scale, utilizing the arbitrary beam steering capability of galvanometers at the increased speed requires making the modifications to both scanners in the system simultaneously. The disclosed afocal 1D beam compressor described in section 3.2.1 works well for both X- and Y-scanners.

### 4. Design Examples

For inertially limited scanners (i.e. galvos and resonant scanners), the weight, which is tied to the mirror size, limits how quickly (line rate) you can scan, placing a tension between the number of resolvable points at the imaging plane and the line rate. The problem of the optical invariant, however, only applies to the direction of scanning, meaning that in the direction that is not being scanned, we are free to reshape the beam without impacting the number of resolved points.

A feature of embodiments disclosed herein is that they reshape the incident optical beam along an unscanned axis. This allows the scanner to be reshaped, decreasing the moment of inertia, without reducing the number of resolvable points or optical angular range. This relies primarily on cylindrical optical surfaces, which focus in one direction while leaving the other direction of the beam unaffected.

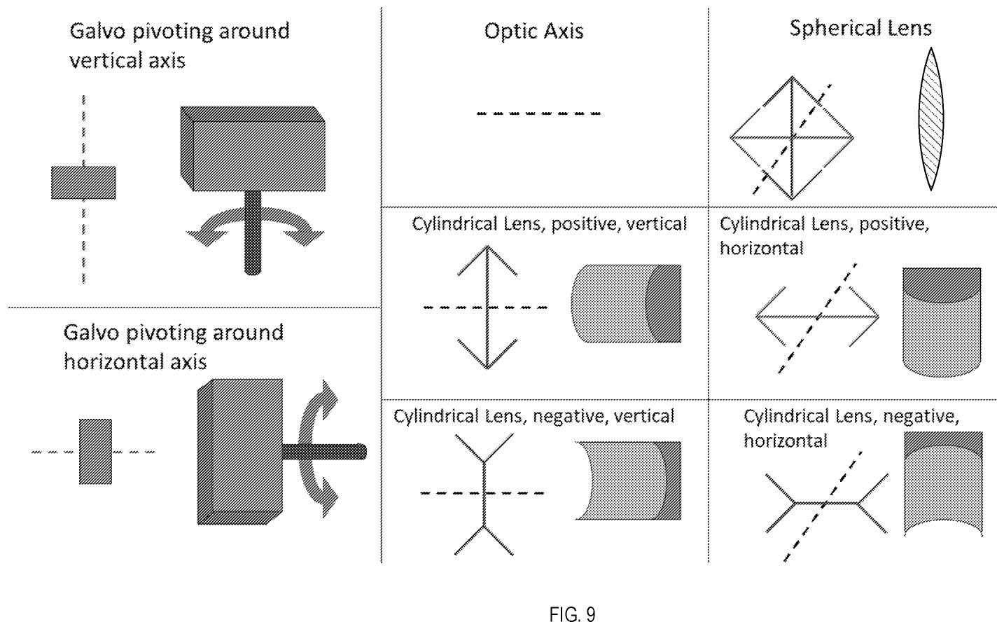

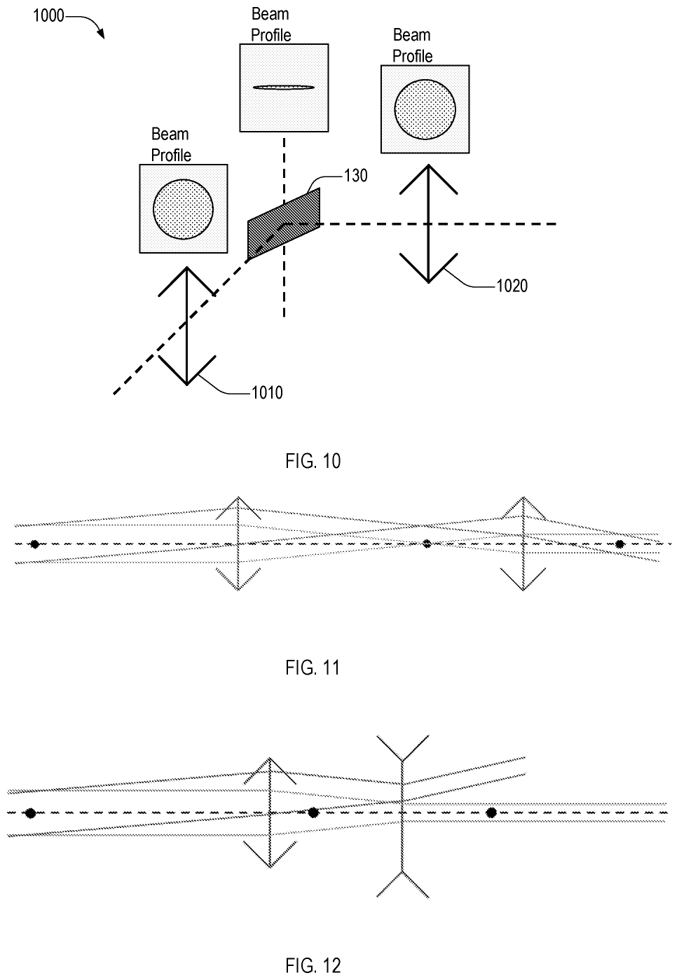

FIG. 9 is a legend defining the meaning of symbols used in subsequent schematics of optical systems. FIG. 10 is a schematic of an optical scanner 1000 that includes a cylindrical lens 1010 focusing a beam onto scanning optical-element 130 with a second cylindrical lens 1020 recollimating after scanning. While FIG. 10 depicts each of lenses 1010 and 1020 as a singlet lens, lenses 1010 and 1010 may include more than one cylindrical surfaces (and/or cylindrical lens elements) to produce the same effect while incurring less beam aberration. lenses 1010 and 1020 are examples of optical-element 110 and optical-element 120, respectively.

Instead of focusing the beam on the mirror, the beam is reshaped to be collimated but elliptical as it approaches scanning optical-element 130. These systems may be broadly categorized into a one-dimensional Keplerian telescope (FIG. 11) or a one-dimensional Galilean telescope (FIG. 12). A Keplerian telescope includes two positive lenses with a shared focal point. The ratio of the focal lengths of the two lenses determines the magnification, and thus ellipticity of the cylindrical lens system. A Galilean telescope includes a positive lens and a negative lens also sharing focal point. The ratio of the focal lengths also determines the magnification.

These telescopes have potential advantages over simply focusing the beam on the scanner. The Galilean telescope is more compact and produces less off axis defocus than the singlet system. The Keplerian telescope forms a real image. In embodiments, modification of both scanners in a system (necessary for speeding up a galvo system forming arbitrary scan paths since neither axis is the faster axis) requires the scanners to be conjugate to each other. Accordingly, the beam reshaping leading to the second scanner may include Keplerian telescope design.

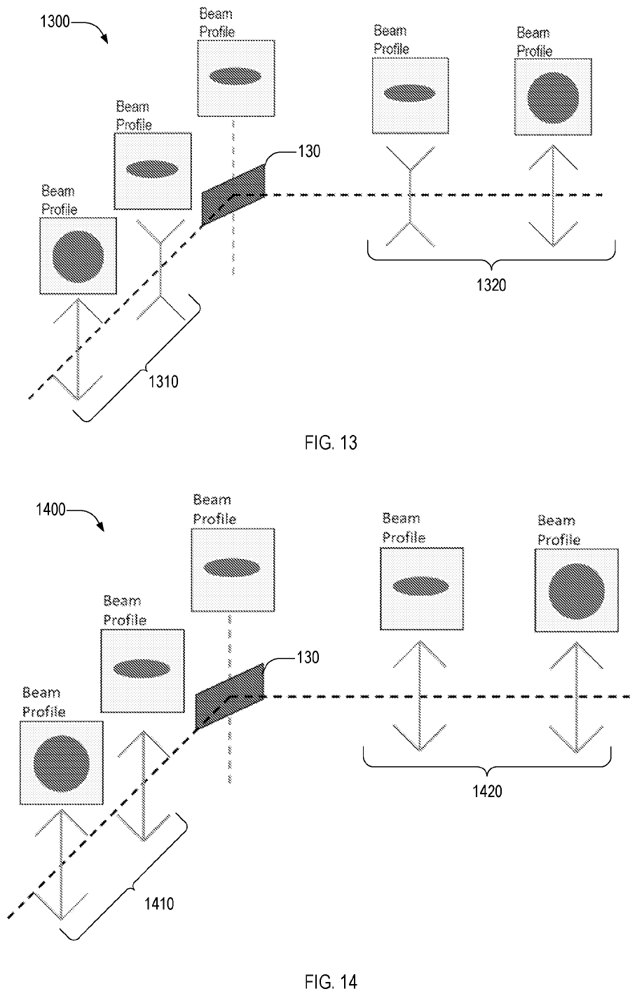

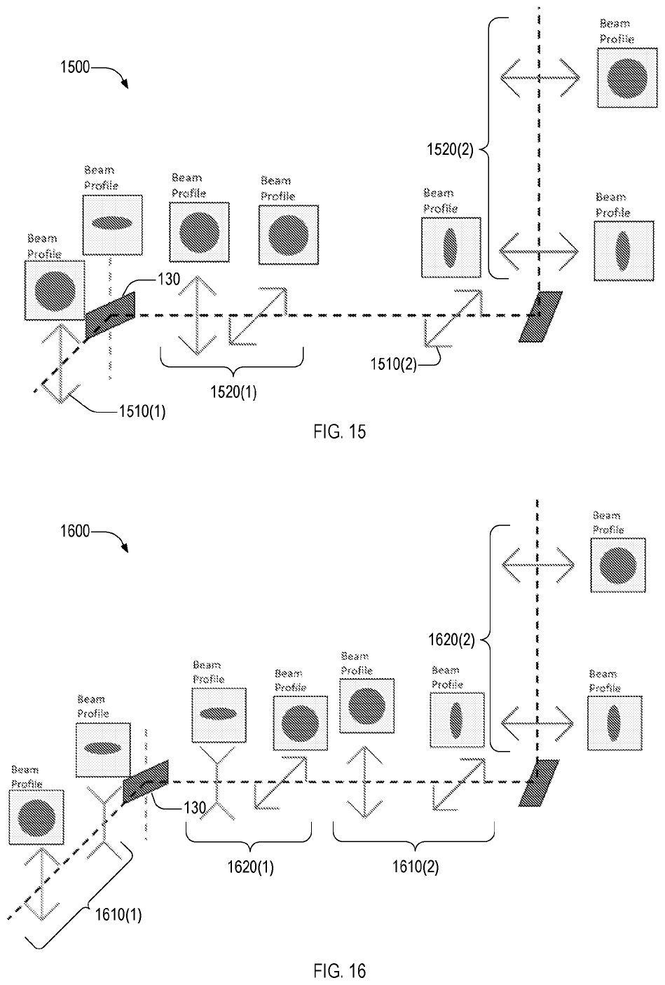

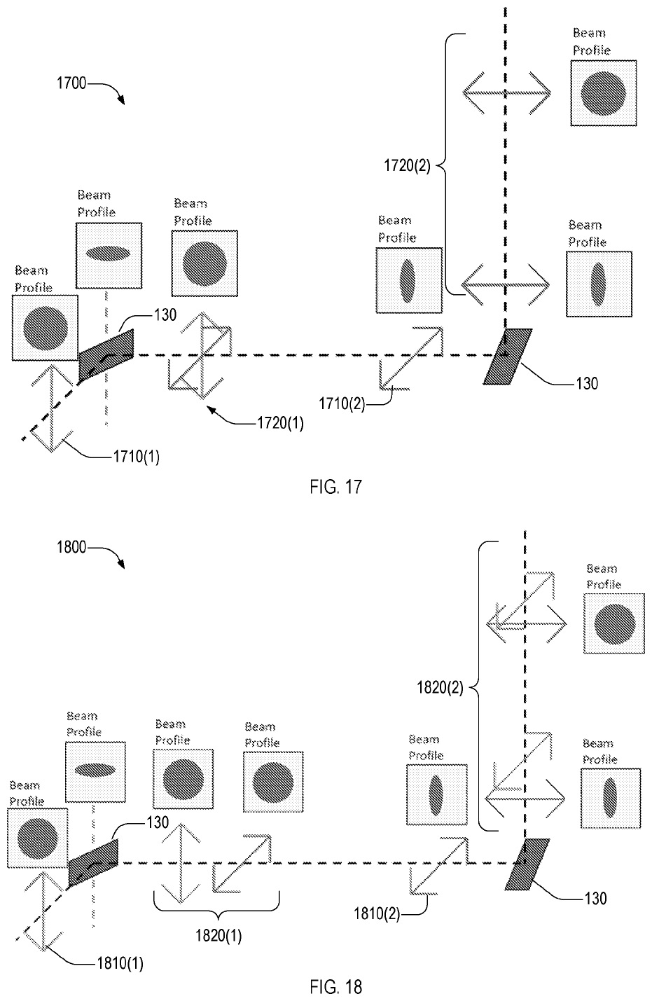

FIGS. 13 and 14 are schematics of an optical scanner 1300 and 1400, respectively, each of which are examples of optical scanner 100. FIGS. 15-18 are respective schematics of dual-scanners 1500, 1600, 1700, and 1800, which include two instances of optical scanner 100 for scanning in a horizontal plane and a vertical plane. Optical scanners 1300-1800 include optical elements 1310, 1410, 1510, 1610, 1710, and 1810 respectively, each of which is an example of optical-element 110. Optical scanners 1300-1800 also include optical elements 1320, 1420, 1520, 1620, 1720, and 1820 respectively, each of which is an example of optical-element 120.

The first scanner of a dual-scanner may be conjugate to the second along both axis. Additionally, since the beam axis are being modified independently, the ordering of elements of the relay is independent of the reshaping elements of the first scanner. When one type of telescope is on one side of a scanner, a different type of telescope may be on the other side (i.e. Keplerian shaping the beam before the second scanner, but Galilean restoring it) so long as the magnification is appropriate.

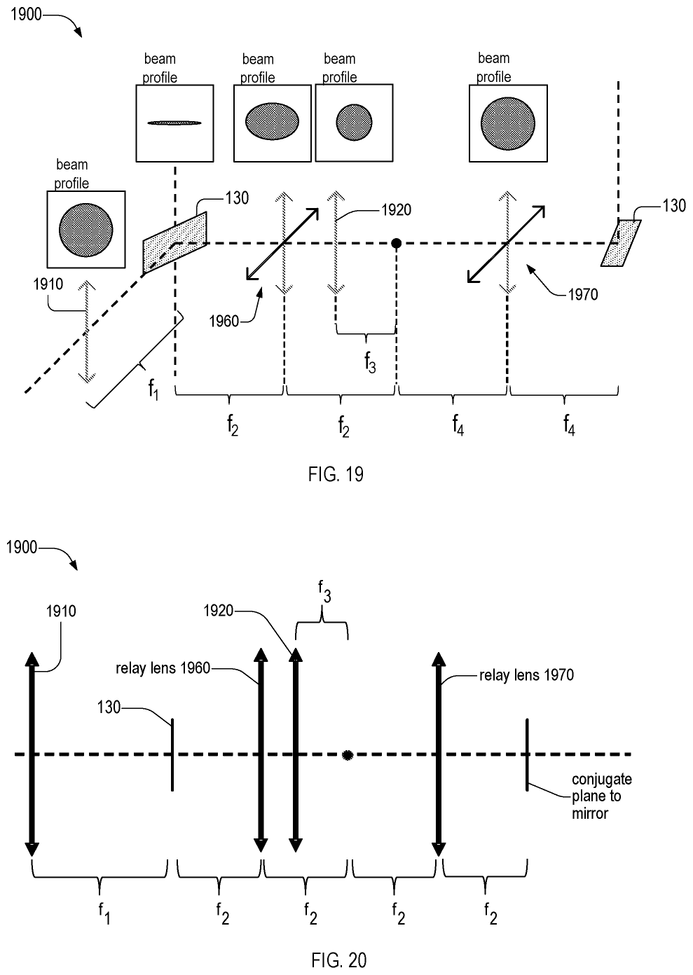

FIGS. 19 and 20 are schematics of an optical scanner 1900 which is an example of optical scanner 100. Optical scanner 1900 includes scanning optical-element 130, and also optical elements 1910 and 1920, which are examples of optical elements 110 and 120, respectively. Optical scanner 1900 also includes relay lenses 1960 and 1970, each of which may be spherical or have axial symmetry. Each of optical elements 1910 and 1920 may be a cylindrical lens. Optical element 1910, relay lens 1970, and optical elements 1920 have respective focal lengths f₁, f₂, and f₃.

After relay lens 1960, an incident optical beam is collimated along the A2 axis and focusing along the A1 axis (since the focal point is shared with the optical element 1910). Optical element 1920 is between relay lenses 1960 and 1970, and shares the inner focal point with relay lenses 1960 and 1970. To retain this order of elements (condition 1), the following relationship is satisfied: f₃<f₂<f₁. To ensure the beam profile is circular at relay lens 1970 (condition 2), we have f₂/f₁ equals f₃/f₂. Expressed differently, in embodiments of optical scanner 1900,

$${f}_{3} = {f}_{2}^{2} / {f}_{1} = {f}_{2} ( {f}_{2} / {f}_{1} ) < {f}_{2} ,$$

so both condition 1 and condition 2 may be met simultaneously. As a consequence of the Fermat principle, the optical path length of the beam from the scanner to the second cylindrical lens is constant regardless of scanner angle, meaning that the defocusing problem is mitigated.

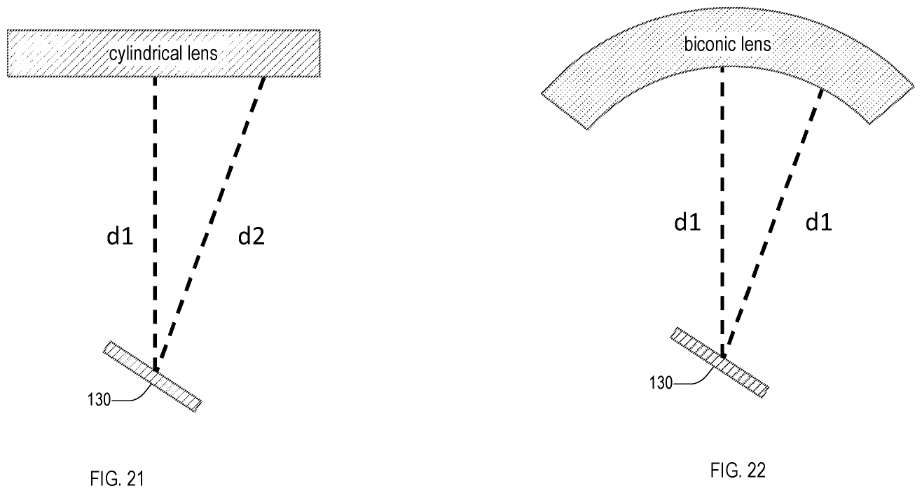

A cylindrical lens has translational symmetry in one direction. As the beam is scanned, and the angle to the lens changes, the distance from the beams focus to the lens changes, as shown in FIG. 21, where distance d2 differs from d1. This leads to a one-dimensional defocusing of the beam which is dependent on the scanner angle. This limits the angular range of the scanning system.

We can mitigate this problem by curving the cylindrical lens, such that the surfaces are no longer be cylindrical but biconic, as shown in FIG. 22. Appropriate choice of curvature in the scanning direction for both surfaces causes the optical power of the surfaces to cancel out. As a result, similar to the cylindrical lens, the optic has focusing power in one direction but not in the other. Additionally, the distance from the lens to the scanning pivot remains constant across the optic, eliminating the defocus problem and expanding the usable angular range.

Features described above, as well as those claimed below, may be combined in various ways without departing from the scope hereof. The following enumerated examples illustrate some possible, non-limiting combinations.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments.

The use of any of the symbol/term “/”, “and/or” and “at least one of,” for example, in the cases of “A and/or B” and “at least one of A and B”, such phrasing encompasses the selection of (i) A only, or (ii) B only, or (iii) both A and B. In the cases of “A, B, and/or C” and “at least one of A, B, and C,” such phrasing encompasses the selection of (i) A only, or (ii) B only, or (iii) C only, or (iv) A and B only, or (v) A and C only, or (vi) B and C only, or (vii) each of A and B and C. This may be extended for as many items as are listed.

The following claims are intended to cover all generic and specific features described herein, as well as all statements of the scope of the present method and system, which, as a matter of language, might be said to fall therebetween.

1. An optical scanner comprising a first 1D-beam-shaping optical-element, a scanning optical-element, and a second 1D-beam-shaping optical-element, wherein:
the first 1D-beam-shaping optical-element flattens an incident optical beam in a vertical direction to yield a flattened input-beam that propagates toward the scanning optical-element;
the scanning optical-element deflects the flattened input-beam, in a scanning plane, to yield a flattened output-beam that propagates to the second 1D-beam-shaping optical-element along one of multiple optical beam paths in a scanning plane; and
the second 1D-beam-shaping optical-element collimates the flattened output-beam.

2. The optical scanner of claim 1, the scanning optical-element having a vertical dimension and a horizontal dimension that exceeds the vertical dimension.

3. (canceled)

4. The optical scanner of claim 1, the scanning optical-element being a mirror that (i) faces each of the first and the second 1D-beam-shaping optical-elements and (ii) reflects the flattened input-beam to the second 1D-beam-shaping optical-element.

5. The optical scanner of claim 4, further comprising a galvo scan head that includes the mirror, and pivots the mirror about a vertical axis.

6. The optical scanner of claim 1, the scanning optical-element being a refractive optical-element.

7. The optical scanner of claim 1, (i) the first 1D-beam-shaping optical-element being a down-collimator that compresses the incident optical beam in the vertical direction, and/or (ii) the second 1D-beam-shaping optical-element being an up-collimator that expands the flattened output-beam in the vertical direction.

8. The optical scanner of claim 1,
the first 1D-beam-shaping optical-element having, on a side facing away from the scanning optical-element, an entrance clear-aperture in the vertical direction, and
the scanning optical-element having a vertical dimension and a horizontal dimension that exceeds the vertical dimension, the vertical dimension being less than or equal to the entrance clear-aperture.

9. The optical scanner of claim 1, each of the first and the second 1D-beam-shaping optical-elements including a surface that lacks axial symmetry.

10. The optical scanner of claim 1, each of the first and the second 1D-beam-shaping optical-elements including a non-planar surface that has mirror symmetry about a respective symmetry plane.

11. The optical scanner of claim 10, the scanning plane being a horizontal plane, each of the respective symmetry planes being parallel to and/or coplanar with the scanning plane.

12. (canceled)

13. The optical scanner of claim 1, at least one of the first and the second 1D-beam-shaping optical-elements including one of a cylindrical lens, a cylindrical mirror, a one-dimensional parabolic mirror, a biconic lens, and a Powell lens.

14. The optical scanner of claim 1,
the first 1D-beam-shaping optical-element having optical power in a vertical cross-sectional plane thereof, and
the scanning optical-element having a vertical dimension and a horizontal dimension that exceeds the vertical dimension.

15. The optical scanner of claim 14, the first 1D-beam-shaping optical-element lacking optical power in a horizontal plane.

16. The optical scanner of claim 1, the second 1D-beam-shaping optical-element having optical power in a vertical cross-sectional plane thereof.

17. The optical scanner of claim 16, the second 1D-beam-shaping optical-element lacking optical power in a horizontal cross-sectional plane thereof.

18. The optical scanner of claim 1,
each of the first and the second 1D-beam-shaping optical-element having optical power in a vertical cross-sectional plane thereof,
a first distance between a first location on the scanning optical-element and a first principal plane of the first 1D-beam-shaping optical-element being substantially equal to a first focal length of the first 1D-beam-shaping optical-element; and
a second distance between a second location on the scanning optical-element and a second principal plane of the second 1D-beam-shaping optical-element being substantially equal to a second focal length of the second 1D-beam-shaping optical-element.

19. The optical scanner of claim 18,
the first distance differing from the first focal length by less than a first depth of focus of the first 1D-beam-shaping optical-element; and
the second distance differing from the second focal length by less than a second depth of focus of the second 1D-beam-shaping optical-element.

20. (canceled)

21. A method for angularly scanning an optical beam, comprising:
forming a flattened input-beam from the optical beam by decreasing a height of the optical beam in a vertical direction, perpendicular to a scanning plane, while substantially maintaining a width of the optical beam in a horizontal direction;
deflecting the flattened input-beam to yield a flattened output-beam; and
forming an expanded optical beam from the flattened output-beam by increasing a height of the flattened output-beam in the vertical direction.

22. The method of claim 21, the optical beam being incident on a scanning optical-element of an optical scanner, said forming the flattened input-beam occurring before the optical beam reaches the scanning optical-element.

23.-28. (canceled)

29. The method of claim 21, deflecting comprising: deflecting the flattened input-beam with an optical element that has a vertical dimension and a horizontal dimension that exceeds the vertical dimension.
